(19) United States
(12) Patent Application Publication
(10) Pub. No.: US 2008/0261193 A1
(43) Pub. Date: Oct. 23, 2008

(54) Management Information System

(75) Inventor: David Serwitz, San Luis Obispo, CA (US)

Correspondence Address: LAW OFFICE OF PHILIP A STEINER, 1212 MARSH STREET, SUITE 3, SAN LUIS OBISPO, CA, 93401, US

(73) Assignee: Make the Grade Franchise Corporation, San Luis Obispo, CA (US)

(21) Appl. No.: 11/736,368

(22) Filed: Apr. 17, 2007

(51) Int. Cl. G09B 5/00

(52) U.S. Cl. 434/350

(57) ABSTRACT

A management information system, computer implemented method and computer product for managing tutoring services. A networked server is provided which includes a processor, a memory coupled to the processor and a database operatively stored in the memory. The database comprises a first database component operative to maintain a plurality of tutor records, each tutor record being associated with an individual tutor and including tutoring data representing an available tutoring subject and a tutoring locality; a second database component is operative to maintain a plurality of student records, each student record being associated with an individual student and including student data representing a requested tutoring subject and a student locality. A database engine is operatively loaded into the memory and includes instructions executable by the processor to determine a suggested tutor/student allocation in dependence on a correspondence of at least the data representing a tutoring subject and locality among the tutor and student records, generate a suggested tutor/student allocation and output the suggested tutor/student allocation in a tiered order of preference of tutors and sends notices to the identified tutors.

### CROSS-REFERENCE TO RELATED APPLICATIONS

Not applicable

### FEDERALLY SPONSORED RESEARCH AND DEVELOPMENT

Not Applicable

### REFERENCE TO A MICROFICHE APPENDIX

Not Applicable

### RELEVANT INVENTIVE FIELD

The various inventive embodiments relates generally to management information systems and more specifically to a system, method and computer program product for a management information system associated with a tutoring service.

### BACKGROUND

Students desiring tutoring assistance generally have limited choices in obtaining personalized assistance. Frequently, the tutoring assistance is provided at a time and place convenient to the tutor but not that of the student. Moreover, the tutoring does not reflect the educational curriculum which has become problematic to the student. Therefore, the tutoring experience is of limited immediate value to the student. A further challenge is encountered when attempting to address the deficiencies in the relevant art as current tutoring educational systems are directed toward providing online tutoring rather than supplying the tutoring in person at a time and place convenient to the student.

### SUMMARY

Various exemplary embodiments as described herein addresses the desirable aspects lacking in the relevant art and provides in various exemplary systematic, methodic, and computer program embodiments of a Tutoring Services Management Information System (MIS.) In an exemplary embodiment, a client-server arrangement is provided in which a plurality of browser equipped client computer systems are in networking communications with a server. The server includes a processor, a memory and a database operatively stored in the memory.

The database is arbitrarily divided into separate components, modules or engines for simplicity in explanation only. A first database component maintains a plurality of tutor records, each tutor record being associated with an individual tutor and including tutor data. The tutoring data includes available tutoring subjects and tutor locality information.

A second database component maintains a plurality of student records, each student record being associated with an individual student and including student data representing a requested tutoring subject and a student's locality. A third database component may be provided to maintain a plurality of accounting records, each set of the accounting records being associated with a tutor/student relationship and including accounting data representing accounts receivable and accounts payable.

As examples, the data representing accounts receivable includes invoices to a student for tutoring services rendered and the data representing account payable including electronically submitted timecard data associated with a tutor/student relationship.

In an exemplary embodiment, a third database component is provided to maintain a plurality of accounting records, each accounting record being associated with an established tutor/student relationship and data representing accounts receivable and accounts payable.

In a related exemplary embodiment, the database engine further comprises instructions which when executed by the processor causes the processor to output the accounting records in a standardized data exchange format.

In another related exemplary embodiment, the data representing accounts payable data includes electronically submitted timecard data received from each tutor associated with the established tutor/student relationship.

In yet another related exemplary embodiment, the standardized data exchange format is selected from the group consisting of; an extensible markup language format, a QuickBooks format, a Peachtree Accounting format, an open financial exchange format, an Office Accounting Express format and a spreadsheet format.

In an exemplary embodiment, an optional fourth database component may be provided to maintain a plurality of referral records, each set of the referrals records being associated with a tutor/student relationship.

A database engine is operatively loaded into the memory and includes instructions executable by the processor to determine and generate a suggested tutor/student allocation in dependence on a correspondence of the data representing a tutoring subject and a locality among the tutor and student records. The suggested tutor/student allocation is then output in a tiered order of preference of tutors. In an exemplary embodiment, a first tier of the tiered order of preference represents a group of most preferred tutors, a second tier represents a group of second most preferred tutors and a third tier representing a group of third most preferred tutors available for the suggested tutor/student allocation.

In an exemplary embodiment, the tutor records further comprises tutor data representing tutor qualifications, tutor availability, prior student feedback ratings, prior student feedback ratings and billing rates; and the student records further comprises student data representing student availability, student preferences and relationships with one or more tutoring providers.

In an exemplary embodiment, the database engine further comprises instructions which when executed by the processor cause the processor to generate the suggested tutor/student allocation in further dependence on a correspondence of the data representing the data representing tutor and student availability.

In an exemplary embodiment, the database engine further includes instructions which when executed by the processor causes the processor to send a message to each tutor in the first tier which requests acceptance of the suggested tutor/student allocation and if no acceptance is received from the first tier tutors within the predefined time period, send a message to each tutor in the second tier which requests acceptance of the suggested tutor/student allocation; if no acceptance is received from the second tier tutors within the predefined time period, send a message to each tutor in the third tier which requests acceptance of the suggested tutor/student allocation; and, if no acceptance is received from the third tier tutors within the predefined time period, send a message to an administrator.

Lastly, the Company database and database engine may be provided in a tangible form comprising magnetic media, optical media, and logical storage media readable by the processor.

### BRIEF DESCRIPTION OF THE DRAWINGS

The features and advantages of the exemplary inventive embodiments will become apparent from the following detailed description when considered in conjunction with the accompanying drawings. Where possible, the same reference numerals and characters are used to denote like features, elements, components or portions of the various exemplary embodiments. It is intended that changes and modifications can be made to the various described exemplary embodiments without departing from the broader true scope and spirit of the inventive concept.

FIG. 1—depicts an exemplary block diagram of a server computer system.

FIG. 2—depicts an exemplary block diagram of a networked arrangement in which the server computer system is in networking communications with a plurality of client computer systems.

FIG. 3—depicts an exemplary hierarchical structure of a database associated with a tutoring services management information system.

FIG. 3A—depicts an exemplary pseudo-programmatic arrangement of the tutoring services management information system.

FIG. 3B—depicts a continuation of the exemplary pseudo-programmatic arrangement of the tutoring system management information system.

FIG. 3C—depicts a plurality of exemplary tables comprising tutor, student, Regional Service Provider, Company and Referral information

FIG. 4—depicts an exemplary process flow chart of the tutoring services management information system.

FIG. 4A—depicts a continuation of the exemplary process flow chart of the tutoring services management information system.

### DETAILED DESCRIPTION

In various exemplary embodiments, a Management Information System (MIS) is provided in which one or more Regional Service Providers, for example, franchisees which are assigned territories by a Company, for example a franchisor. The Company provides access to a networked server which allows the company to access financial and business records of each of its contracted Regional Service Providers. In an exemplary embodiment, each Regional Service Provider maintains its own sets of records which are centralized on the networked server along with other Regional Service Providers. The centralization of records of the Regional Service Providers allows for economies of scale to be realized in relation to centralized financial accounting and centralized financial management by the Company provider.

In an exemplary embodiment, the Regional Service Provider arrangement utilizes contract tutors such as college students, current teachers, retired teachers and retired college professors to provide home tutoring services to students. The use of contract tutors reduces overhead costs and simplifies accounting. Each tutor negotiates with a Regional Service Provider for his or her billing rates and payment of expenses. Another aspect of the tutoring arrangement is that the Regional Service Providers are granted territories based on a concentration of educational institutions within a defined locality.

The tutoring provided by the Regional Service Provider may therefore be directed specifically towards the curriculum taught by educational institutions within their defined territory. For example, a particular textbook for high school algebra used by an educational institution may also used by the Regional Service Provider to provide specific tutoring to a student. Tutoring may be provided at any grade school or college-level curriculum or any other academic curriculum deemed appropriate. Each Regional Service Provider is responsible for recruiting of tutors and generating business from students within the Regional Service Provider's assigned territory. However, a tutor is not restricted to providing service to a particular Regional Service Provider.

As an independent contractor, a tutor may provide services for any number of Regional Service Providers and individually negotiate the terms and conditions of his or her contract with the specific Regional Service Provider.

The server may also maintain records regarding referrals of students and/or tutors for payment of gratuities. If the referring entity is a public institution, a donation to a charity may be provided. Alternately, a referral made by a private person or entity may receive a portion of the net income obtained from the student by the applicable Regional Service Provider.

It will be appreciated that the MIS may be used but not limited to supporting business operations for other personalized services including the arranging and scheduling of personalized physical fitness training, home healthcare providers, nursing services, consulting services and personnel recruiting services.

Where necessary, computer programs, algorithms and routines are envisioned to be programmed in a high level language object oriented language, for example Java™, C, C++, C#, CORBA, Visual Basic™. Database components may utilize any common database program, by way of example and not limitation, ORACLE™, Sequel Server™, MySQL™, SQL™, MS ACCESS™, DB2™, MS FOXBASE™, DBASE™, PostgreSQL™and RBASE™

For purposes of this specification, the term “program” is intended to be interpreted in its broadest sense to include all instructions executable by a processor whether embodied in hardware or software. Where applicable, references to various programs may be made in both singular and plural form. No limitation is intended by such grammatical usage as one skilled in the art will appreciate that multiple programs, objects, subprograms, subroutines, algorithms, applets, contexts, etc. may be implemented programmatically to implement the various inventive embodiments.

### Hardware System Configuration

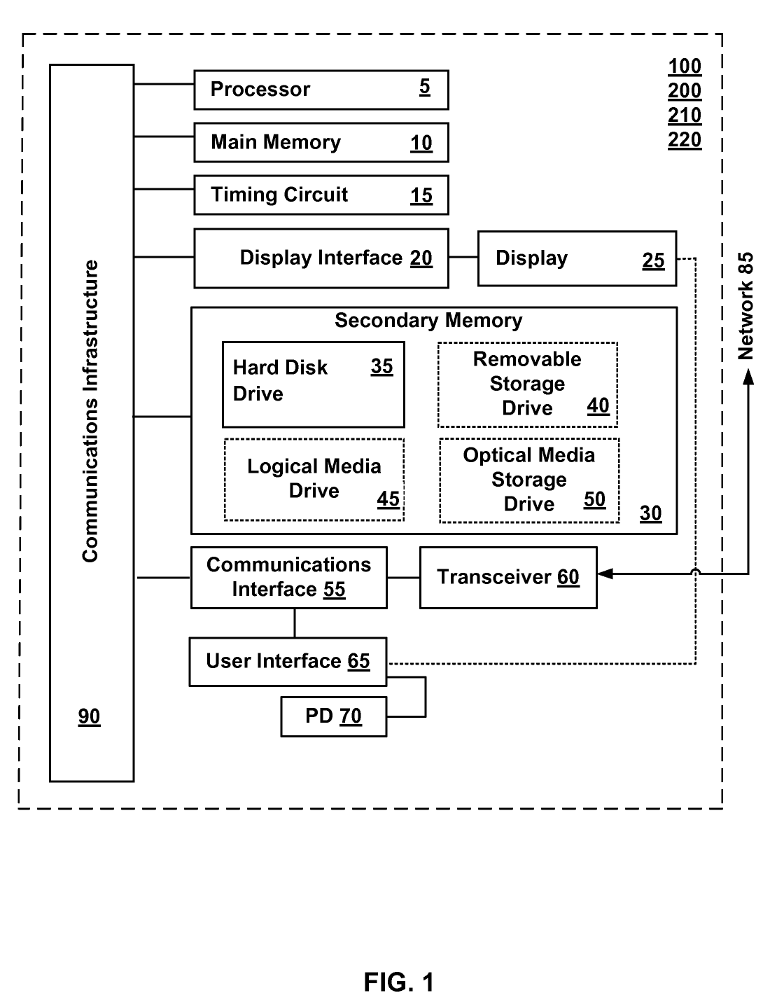

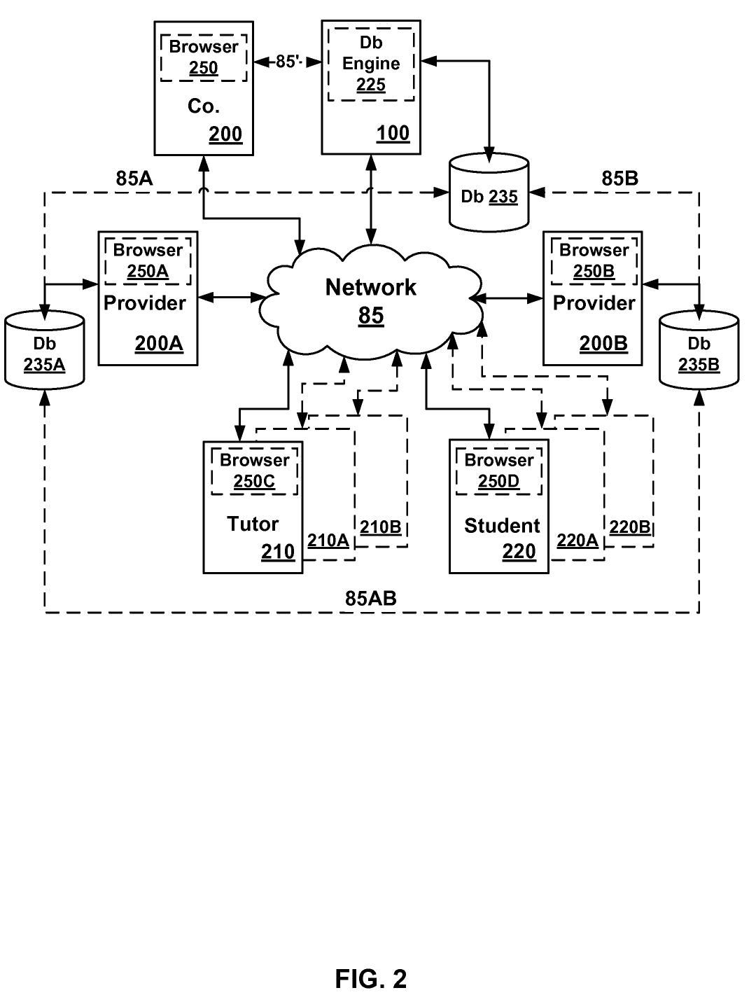

Referring to FIG. 1, a generalized block diagram of an exemplary computer system is depicted. The computer system is illustrative of a server 100 and plurality of networked clients 200, 210, 220 (FIG. 2.) For simplicity and ease of understanding, the term “networked server” 100 will be used hereinafter. However, the same general computer configurations apply to the networked clients 200, 210, 220 as well. The specific functionality of the various computer system implementations will be provided in the discussion accompanying FIG. 2 below.

The networked server 100 includes a communications infrastructure 90 used to transfer data and memory addresses where data files are to be found and control signals among the various components and subsystems associated with the networked server 100. As such, the communications infrastructure 90 provides the input/out (I/O) between and among the various components and subsystems associated with the networked server 100.

A processor 5 is provided to interpret and execute logical instructions stored in the memory 10. One skilled in the art will appreciate that one or more processors 100 may be provided in various server implementations and/or in multi-core integrated processor packages.

The main memory 10 is the primary general purpose storage area for instructions and data to be processed by the processor 5. The term “memory” is to be interpreted in its broadest sense and includes both main memory 10 and secondary memory 30. A collective term of “computer readable storage medium,” may be used to describe either or both the main memory 10 and secondary memory 30 as well.

Where applicable, references to the term “datastore” should be interpreted as an alternative to the term “memory,” and includes the primary 10 and secondary memory 30. A timing circuit 15 is provided to coordinate programmatic activities within the computer 100 in near real time. The timing circuit 15 may be used as a watchdog timer, clock or a counter arrangement and may be separately programmable.

The processor 5, main memory 10 and timing circuit 15 are directly coupled to the communications infrastructure 90. A display interface 20 is provided to drive a display 25 associated with the networked server 100. The display interface 20 is electrically coupled to the communications infrastructure 90 and provides signals to the display 25 for visually outputting both graphical displays and alphanumeric characters.

The display interface 20 may include a dedicated graphics processor and memory (not shown) to support the displaying of graphics intensive media. The display 25 may be of any type (e.g., cathode ray tube, gas plasma) but in most circumstances will usually be a solid state device such as liquid crystal display (LCD.) A secondary memory subsystem 30 is provided which houses retrievable data storage units such as a hard disk drive 35, an optional removable storage drive 40, an optional logical media storage drive 45 and an optional optical media storage drive 50.

The removable storage drive 40 may be a replaceable hard drive, optical media storage drive or a solid state flash RAM device. The logical media storage drive 45 may include a flash RAM device, or an EEPROM encoded with instructions executable by the processor 5. The optical storage media storage drive 50 includes the ability to read and write compact disk (CD) and digital video disk (DVD) media form factors.

A communications interface 55 subsystem is provided which allows for standardized electrical connection of peripheral devices to the communications infrastructure 90 including, PS/2, serial, parallel, USB, and Firewire™ connectivity ports.

For example, a communications network transceiver 60 and a user interface 65 may be electrically coupled to the communications infrastructure 90 via the communications interface 55. The transceiver 60 facilitates the remote exchange of data and synchronizing signals between the networked server 100 and other devices in network communications 85 with the networked server 100. The transceiver 60 is envisioned to be of type normally associated with computer networks based on the various IEEE standards 802.11x, where x denotes the various present and evolving wireless computing standards, for example WiMax IEEE 802.16 and WRANG IEEE 802.22.

Alternately, digital cellular communications formats compatible with for example GSM, 3G, CDMA, TDMA and evolving cellular communications standards. Both peer-to-peer (PPP) and client-server arrangements are envisioned for implementation of the various exemplary embodiments.

For purposes of this specification, the term “user interface” 65 includes the hardware and software by which a user interacts with the networked server 100 and the means by which the networked server 100 conveys information to the user. The user interface 65 may include the display interface 20 and an operatively coupled display 25, for example, inventive embodiments utilizing a touch screen.

The user interface 65 employed may include a pointing device 70 such as a mouse, thumbwheel or track ball, an optional touch screen (not shown); one or more push-button switches (not shown), one or more sliding or circular potentiometer controls (not shown) and one or more additional switches (not shown.)

The user interface 65 provides interrupt signals to the processor 5 via the communications interface 55 and communications infrastructure 90 that may be used to interpret user interactions with the networked server 100. The networked server 100 includes an operating system, the necessary hardware and software drivers necessary to fully utilize the devices coupled to the communications infrastructure 90 and at least an Internet browser 250 (FIG. 2.) The operating system may include the various versions and derivations of Unix™, Microsoft Windows™, and Apple™MAC OS-X. The Internet browser may be of any common type which is compatible with the operating system installed on the networked server 100.

### Network Topography

FIG. 2 depicts an exemplary networked arrangement in which the networked server 100 is in networking communications with a plurality of browser enabled client computer systems 200, 200A,B, 210, 210, 200A,B, 220, 220, 220A,B. The networked server 100 includes a database engine 225 operatively loaded into the memory 10 of the networked server 100. The database engine 225 is functionally coupled to a Company database 235. The Company database 235 includes but is not limited to financial, business, tutor and student records of various Regional Service Providers and a Company in which the Regional Service Providers are in privity. The business records include Regional Service Provider and Company accounts receivable, accounts payable, received income, paid expenses, payroll records, details concerning each Regional Service Provider's assigned territory, and educational institutions within each Regional Service Provider's assigned territory.

In an exemplary embodiment, the networked server 100 may be accessed by a Company client 200 over a private intranet 85′ or via a peer-to-peer communications arrangement. Alternately, the Company client 200 may functionally connect to the networked server 100 over a public network 85, for example, the Internet.

In an exemplary embodiment, the networked server 100 may be may be maintained at a remote location from the Regional Service Providers and Company. Clustering of a plurality of Company servers may be accomplished as well to meet throughput demands of a growing business, data security, uptime reliability and redundancy.

In an exemplary embodiment, the Company maintains administrator level privileges and grants each contracted Regional Service Provider access rights to the networked server 100. The access rights granted to each of the Regional Service Providers allows each Regional Service Provider to access the records associated with their own business but does not normally allow access to other Regional Service Providers unless specifically agreed to by either or both the applicable Regional Service Providers and/or the Company 200. In an exemplary embodiment, each Regional Service Provider 200A, 200B may establish limited accounts having limited access privileges to the tutors 210, 210A,B and contracted students 220, 220A,B on the networked server 100. The limited access accounts allows employees, and optionally; the independent contract tutors and student clients to access records and information specific to the tutor or student but only those within an authorized Regional Service Provider domain on the networked server 100.

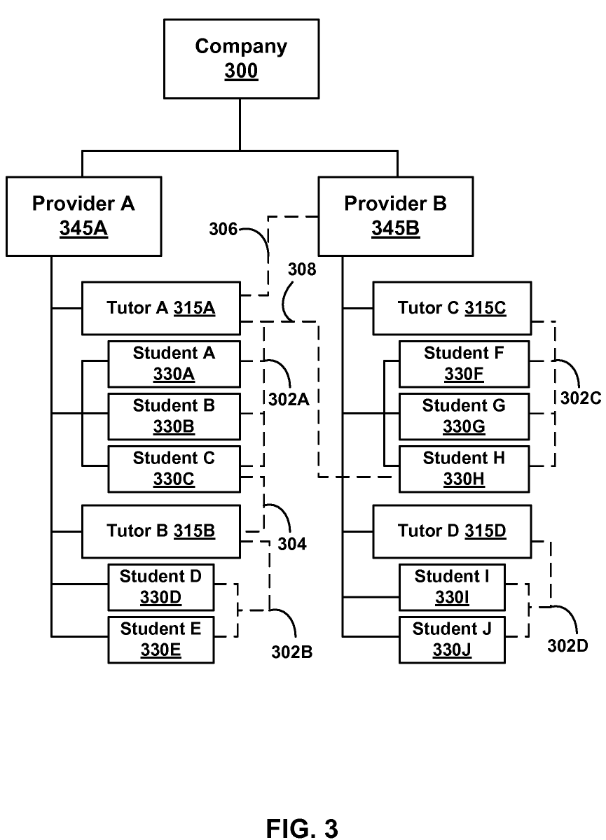

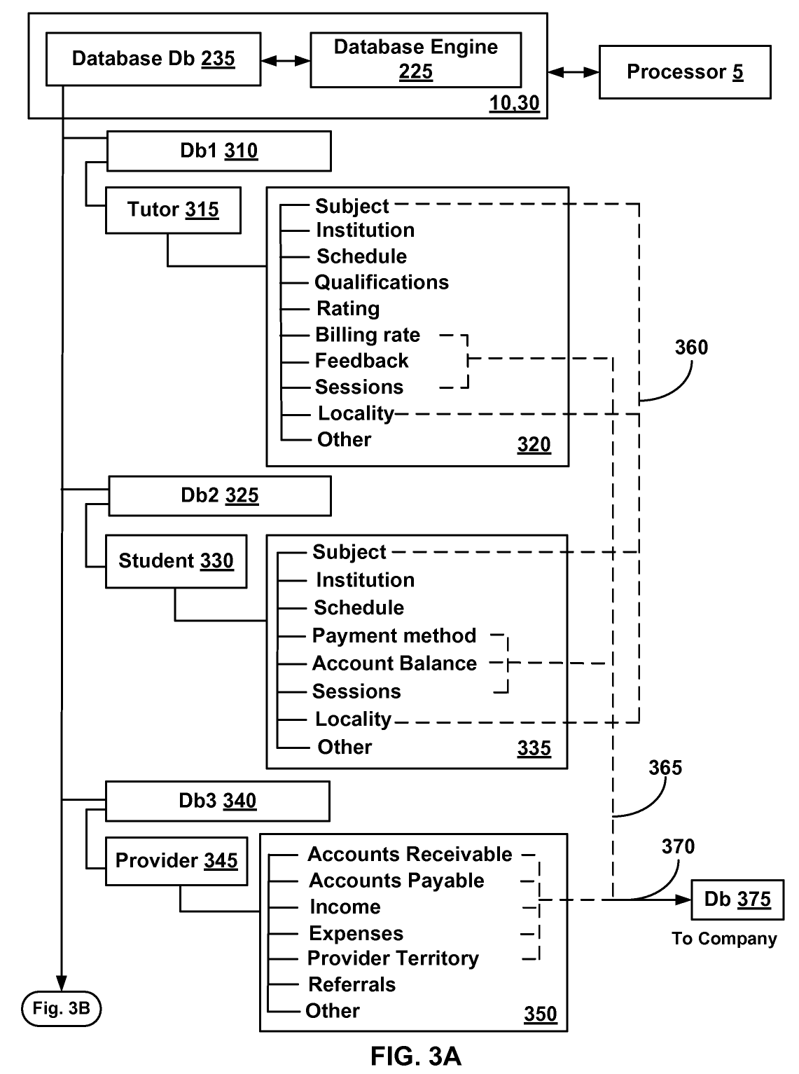

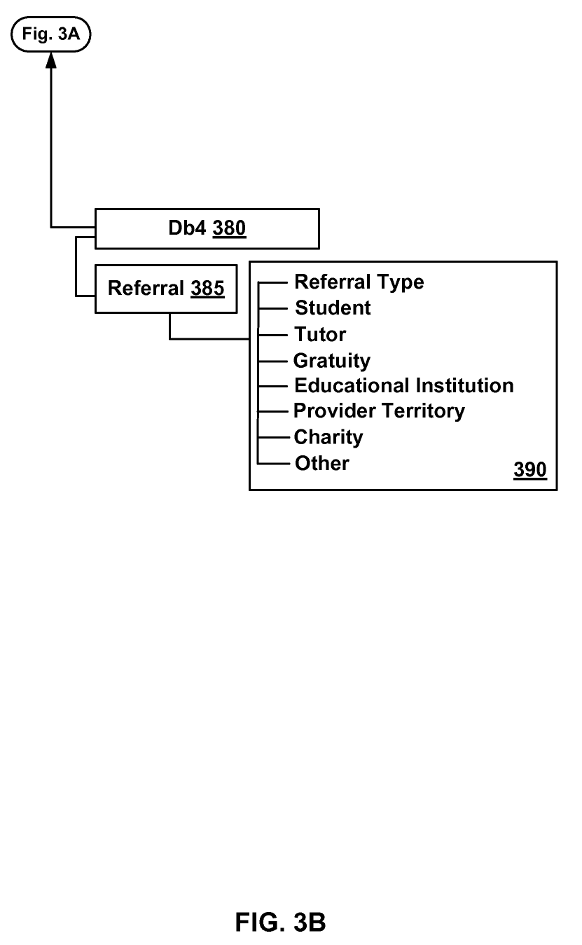

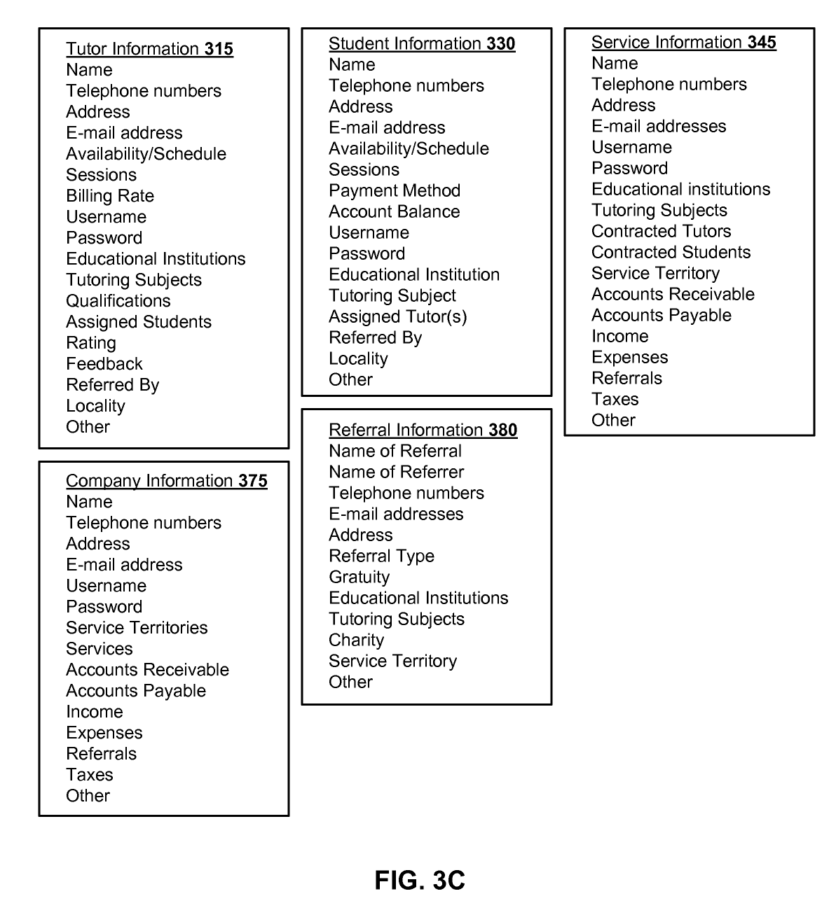

For simplicity and ease of understanding, two Regional Service Provider clients 200A,B are depicted in FIG. 2. Each Regional Service Provider accesses the networked server 200 by a local browser equipped client 200A,B via the public network 85. Each Regional Service Provider is assigned the responsibility to maintain records specific to its assigned regional territory. The records include financial information, student information, tutor information, educational institution information of associated with the Regional Service Provider's assigned territory and optionally referral information. A more detailed description of the information maintained on the networked server 100 is provided in the discussion accompanying FIG. 3C below.

In an exemplary embodiment, a plurality of tutor clients 210, 210A,B may access the networked server 100 over the public network 85 to receive messages regarding potential tutoring opportunities, electronically recording billable tutoring time and related expenses. The messages exchanged between the networked server 100 and the tutor clients 210, 210A,B include but are not limited to electronic mail (E-mail), short message service text (SMS), and instant messaging text IM.

In this exemplary embodiment, each contracted tutor is provided with the proper user credentials and authentication information to access an account assigned by a contracting Regional Service Provider in which the tutor is or has previously provided tutoring services. This arrangement allows for the tutors to add and/or update their personal information directly rather than having to rely on Regional Service Provider personnel. For example, the tutor's name, address, telephone numbers, email addresses, qualifications, tutoring subject matter, educational institution, locality, availability schedule, billing rate and professional credentials. In an exemplary embodiment, the tutor may also review feedback submitted by students based on the tutoring sessions provided by the tutor.

In an exemplary embodiment, a tutor accesses the networked server 100 from his or her own tutor client 210, 210A,B to receive tutoring requests, enter time spent tutoring a student. This arrangement allows for time-keeping using electronic “timecards,” which may be submitted to the appropriate Regional Service Provider for approval and payment by the Company. In an exemplary embodiment, the submitted electronic timecards are reviewed and certified for payment by the Regional Service Provider and a check for payment issued by the Company.

In an exemplary embodiment, a plurality of student clients 220, 220A,B may likewise be granted limited access to the networked server 100 over the public network 85. In this exemplary embodiment, each student is provided with the proper user credentials and authentication information to access an account assigned by the contracted Regional Service Provider in which the student is or has been receiving tutoring services. This allows the student to receive notices regarding tutor assignments and enter and/or update personal information, for example, name, address, telephone numbers, email addresses, payment information and/or method (credit card, pay per session, prepayment plans, etc.) requested tutoring subject matter, locality, availability schedule, educational institution, and entry of tutor feedback.

In the above described exemplary embodiments, the Regional Service Provider may assign the tutors and students with a username and password to access their accounts on the networked server 100. In another exemplary embodiment, a digital certificate may be issued to the students and tutors accessing the networked server 100. The digital certificate may be used to authenticate the students and/or tutors and is typically associated with the access privileges granted by the contracting Regional Service Provider.

In an exemplary embodiment, each Regional Service Provider client 200A,B may also be coupled to a local database 235A,B. In this exemplary embodiment, the local databases 235A,B maintains Regional Service Provider specific information for the Regional Service Provider's assigned territory. For example, tutor information, educational institution information within the Regional Service Provider's assigned territory, students information of students being tutored by the Regional Service Provider, accounts receivable, accounts payable, income and expenses, referrals for students and tutors and tutor recruiting information.

In this exemplary embodiment, each Regional Service Provider's local database 235A,B acts as a distributed database which is functionally linked over the network 85A, 85B with the Company database 235. This exemplary embodiment allows for more autonomous operations by the Regional Service Providers while still maintaining centralized financial and business records with the Company. In a related exemplary embodiment, each local database 235A,B of the Regional Service Providers may be linked over the public network 85AB together to form a distributed database which is also linked to the Company database 235 via the public network 85.

### Company Database

FIG. 3 depicts an exemplary hierarchical structure of a Company database 235. The Company database 235 is organized with the Company 300 having the highest access level. The Regional Service Providers 345A,B occupy a next lower tier access level to the Company database 235. The Regional Service Provider access level is restricted to records related to that Regional Service Provider only. Each Regional Service Provider 345A,B has a plurality of tutors 315A-D who have entered into a contractual relationship with the two depicted Regional Service Providers 345A,B and be provided with a third level of access to the Company database 235. However, the tutor level of access is restricted to only a portion of the contracted Regional Service Providers records. Finally, the student level of access, where provided, is restricted to a further subset of the contracted Regional Service Providers records.

In an exemplary embodiment, tutors A 315A and B 315B have entered into a contractual relationship with Regional Service Provider A 345A, while tutors C 315C and D 315D have entered into a contractual relationship with Regional Service Provider B 345B. Each tutor 315A-D has one or more assigned students 330A-J in which tutoring services are being provided. The tutors 315A-D may enter into a contractual relationship with more than one Regional Service Provider 306. Likewise, a student 330H in one Regional Service Provider's territory 345B may engage 308 a tutor 315A located in another Regional Service Provider's territory 345A. In addition, a student 330C may utilize the tutoring services of one or more tutors 302A, 304.

The students 330A-J usually contract with the Regional Service Providers 345A,B based on the student's locality within a Regional Service Providers assigned territory. The contracting Regional Service Provider matches the contracting student 330A-J to one or more tutors 315A-D based on a tutor/student allocation routine included in the Company database 235. In an exemplary embodiment, the Regional Service Provider territories are determined by the Company 300 based on the geographic distribution of educational institutions within a given locality.

FIG. 3A depicts an exemplary pseudo-programmatic arrangement where a database engine 225 is coupled to a Company database 235. The database engine 235 is operatively installed in the memory 10, 30 of a networked server 100. The database engine 225 includes instructions executable by the processor 5 to perform a tutor/student allocation 360 in dependence on a correspondence of a tutoring subject matter and a locality 360. In a related exemplary embodiment, a correspondence between the student and tutor availability schedule(s) may also be incorporated into the tutor/student allocation.

In an exemplary embodiment, the Company database 235 comprises four components. The first component 310 comprises tutor records 315. The tutor records 315 includes one or more tutoring subjects in which each tutor are qualified to provide, one or more educational institutions in which a tutor has agreed to provide tutoring services to one or more students, availability schedule of the tutor, tutor qualifications, cumulative rating, billing rate, student feedback information, tutoring sessions conducted, the locality in which a tutor has agreed to provide tutoring services and a general comments field. An exemplary table of tutor information is provided in FIG. 3C.

A second database component 325 comprises student records 330. The student records 330 includes one or more subjects a student requests tutoring for, an educational institution in which the student attends if applicable, availability schedule of the student, payment method of the student, account balance of the student, tutoring sessions conducted, the locality in which the student is situated, and other pertinent informational records. An exemplary table of student information is provided in FIG. 3C.

A third database component 340 comprises Regional Service Providers 345. The Regional Service Providers 345 includes accounts receivable for each Regional Service Provider, accounts payable by each Regional Service Provider, income received from students, expenses paid by the Regional Service Provider, student and tutor referrals received by the Regional Service Provider, and a general comments field. An exemplary table of Regional Service Provider information is provided in FIG. 3C.

In an exemplary embodiment, the database engine 225 includes instructions executable by the processor 5 to perform financial transactions based on the tutors billing rate and number sessions the student engaged a tutor. In this exemplary embodiment, the student's account is debited in accordance with a payment method, account balance if applicable and the number tutoring sessions the student has received 365. If the student 330 has provided a retainer rather than alternative payment methods such as credit card or direct debit from a checking account, income is transferred from the student's account and an expense is debited for payment of the tutor 315.

In an exemplary embodiment, the financial transactions may be outputted 370 in a file format or report format specified by the Company 375. For example, a file format *.QIF, *.IIF, *.OFX, *.XLS, *.XML, etc. which is compatible with common financial accounting software including but not limited to QuickBooks™, Peachtree Accounting™, and Office Accounting Express™. The reports may be generated and output in a hardcopy format such that the Company may periodically review the profitability of a particular Regional Service Provider.

FIG. 3B depicts a continuation of the exemplary pseudo-programmatic arrangement where an exemplary fourth database component 380 comprises Referral records 390. The Referral records 390 includes a referral type relating to a student or tutor, the names of the referred person, a gratuity paid to the referrer from the Regional Service Provider income 350, the educational institution for which the referral was derived, the applicable Regional Service Provider Territory, a named charity for which a donation will be made in the name of the referrer and other pertinent information to be included in the Referral records 390. An exemplary table of Referral information is provided in FIG. 3C.

Referring to FIG. 3C, exemplary tables comprising Tutor Information 315, Student Information 330, Regional Service Provider Information 345, Company Information 375 and Referral Information 380 is depicted. Tutor information 315 comprises the name of the tutor, one or more telephone numbers associated with the tutor, the tutor's mailing address, one or more E-mail addresses of the tutor, the tutor's availability schedule, tutoring sessions conducted by the tutor, the tutor's billing rate, the username and password provided to the tutor, the educational institutions in which the tutor has contracted with a Regional Service Provider to provide contractual tutoring services, the qualifications of tutor, tutoring subjects offered by the tutor, students assigned to a tutor, a subjective rating of the tutor, feedback provided by students related to the tutor, referrals by former students and/or educational institutions for a particular tutor, the locality in which the tutor has contractually agreed to provide that tutoring services and other pertinent information.

Student information 330 comprises the name of the student, one or more telephone numbers associated with the student, the student address, one or more e-mail addresses of the student, the student's availability schedule, tutoring sessions received by the student, the payment method, account balance, the username and password provided to the student, the educational institution in which the student is attending, tutoring subjects being received by the student, tutors assigned to the student, if applicable, referral information, the locality in which the student has contractually agreed to receive tutoring services and other pertinent information.

Regional Service Provider information 345 comprises the name of the Regional Service Provider, one or more telephone numbers associated with the individual or entity operating the Franchise, the Regional Service Provider's address, one or more e-mail addresses of the Regional Service Provider, the username and password provided to the Regional Service Provider, educational institutions within the Regional Service Provider's territory, tutoring subjects offered by the Regional Service Provider, accounts receivable, accounts payable, income, expenses, referral information, taxes, and other pertinent information.

Company information 375 comprises the name of the Company, one or more telephone numbers associated with the individual or entity operating the Franchise, the Company's address, one or more e-mail addresses of the Company, the username and password provided to the Company, Regional Service Provider Territories, Regional Service Providers, accounts receivable, accounts payable, income, expenses, referral information, taxes, and other pertinent information.

Referral information 380 comprises the name of the person or educational institution making a referral, one or more telephone numbers associated with the referrer, the referral type (e.g., student or tutor), one or more e-mail addresses of the referrer, educational institution referral is directed toward, tutoring subjects referred, the Regional Service Provider territory of the referral and other pertinent information. Gratuities may be paid to private parties or entities which are paid out of the applicable Regional Service Provider's income. In situations where the referral has been received from a public entity or public employee, the gratuity may be paid to a charitable organization of the referring party's choice.

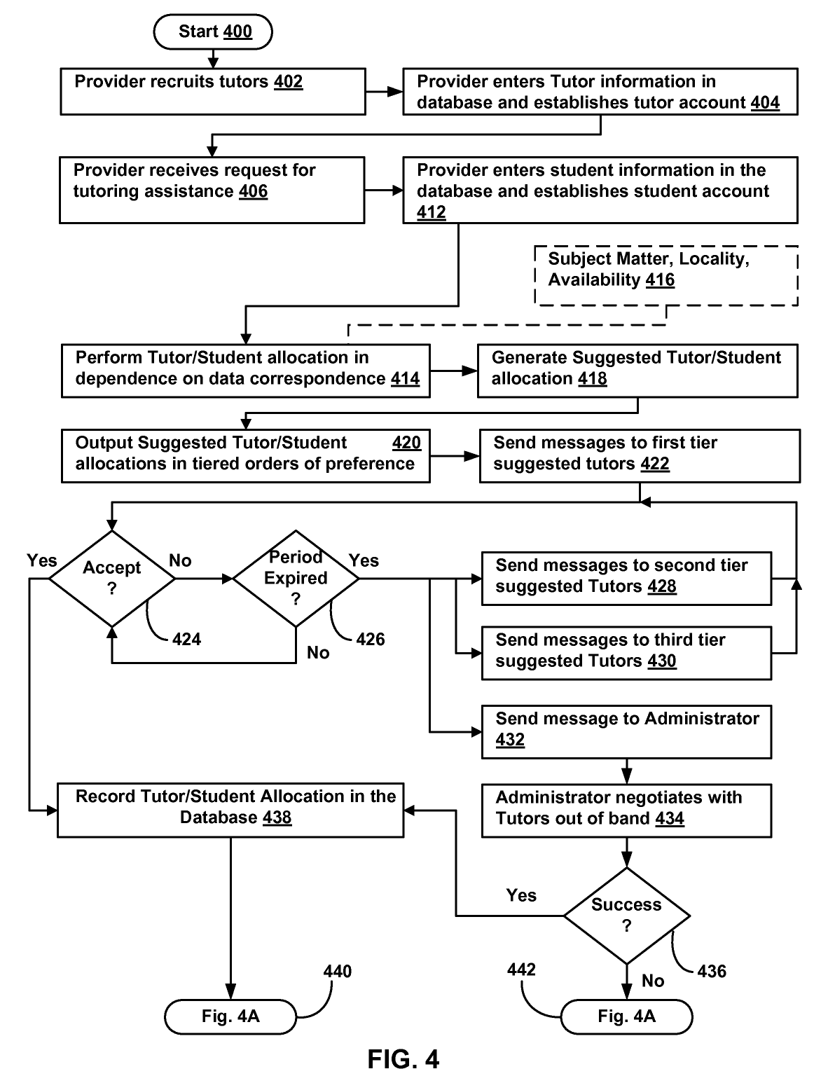

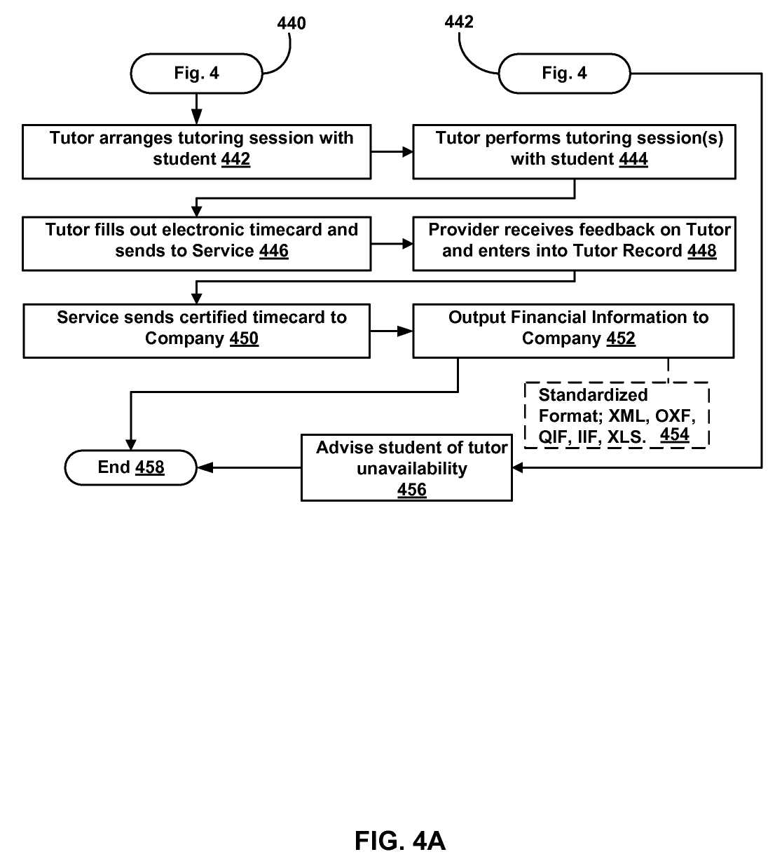

FIG. 4 depicts an exemplary processing implementation of the Tutoring Services Management Information System (MIS.) The process is initiated 400 by a Regional Service Provider recruiting tutors 402 to provide tutoring services to students within the Regional Service Providers assigned territory. Recruiting of tutors may be accomplished by traditional advertising methods and/or via web postings. The Regional Service Provider initially enters the tutor information of the recruited tutors into the Company database 404. In an exemplary embodiment, the Regional Service Provider establishes an account for each recruited tutor which allows future updates and/or changes to the information to be entered directly by the tutors for which the access accounts has been established.

When the Regional Service Provider receives a request for tutoring assistance from a student 406, the student information is recorded in the Company database 412. In an exemplary embodiment, the Regional Service Provider establishes an account for the student which allows future updates and/or changes to the student information to be entered directly by the student for which the access account has been established. The tutor, student and referral information includes some or all of the information shown in FIG. 3C.

The Regional Service Provider then performs a tutor/student allocation using the Company database 414. The Company database attempts to find correspondences between the student and tutor records. As a minimum, requested tutoring subject matter and localities are initially compared. In addition, the availability of the tutor and student are matched to ensure that the initially allocated tutor can meet with the student 416. Other considerations such as tutor qualifications, tutor billing rate, and tutor rating may also be incorporated into the student to the tutor/student allocation as is shown in FIG. 3A. The database engine generates a suggested tutor/student allocation 418. The suggested tutors for the tutor/student allocation are output into a plurality of tiers 420. A first tier represents the most preferable tutors, the second tier represents the second most preferable tutors and the third tier represents the third most preferable tutors. The database engine then sends an electronic message to each tutor in the first tier. The first tier tutors may electronically accept the suggested tutor/student allocation. The database assigns the first responding tutor to the student. A preset time period is established which allows the first tier tutors to electronically respond.

A typical time period is approximately 8 hours, however, any reasonable time period may be used as well. An acceptance 424 by a tutor is recorded in the database as a Tutor/Student Allocation 438. The process continues 440 as provided in the discussion accompanying FIG. 4A.

If an acceptance 424 is not received with the predetermined time period 426, a second set of messages are then sent to each tutor included in the second tier 428. As with the first tier tutors, a second tier tutor may electronically accept the suggested tutor/student allocation. As before, the database assigns the first responding tutor to the student. Again, if an acceptance 424 is not received within the predetermined time period 426, a third set of messages are then sent to each tutor included in the third tier 430.

As before, the database assigns the first responding tutor in the third tier to the student. However, if no tutors electronically accept the suggested tutor/student allocation 424 and the predetermined time period has expired 426, the database sends an electronic message to an Administrator 432. The Administrator will then attempt to negotiate with one or more of the tutors out of band; typically by telephone, to accept the suggested tutor/student allocation. If the Administrator is successful 436 in negotiating a tutor to provide services to the requesting student, the Administrator records the negotiated Tutor/Student Allocation 438. However, if the Administrator is not successful 436 in obtaining a tutor for the requesting student, the process continues 442 as provided in the discussion accompanying FIG. 4A.

Referring to FIG. 4A, the process continues after a tutor/student allocation is recorded in the database 438 by the allocated tutor contacting the requesting student and arranging one or more tutoring sessions with the student 442. The tutor then performs the one or more tutoring sessions with the student 444. The tutor electronically fills out an electronic timecard for the tutoring services rendered to the student and electronically submits the timecard 446. In an exemplary embodiment, the student may also enter feedback comments on the tutor's performance 448 which is recorded in the tutor records portion of the database. The Services Provider reviews the tutor's submitted timecard and certifies the timecard for payment by the Company 450. In an exemplary embodiment, the Service Provider may generate a financial report or data file in a format requested by the Company 452. The format of the financial report may be standardized as an XML, OXF, QIF, IIF, or XLS format 454. Once the financial report has been outputted, processing ends 458. In the continuing situation where Administrator is unable to obtain a tutor for a requesting student 442, the Administrator informs the requesting student 456, typically out of band, and advises him or her of the lack of tutor availability which ends the process 458, until a new cycle is initiated.

This various exemplary inventive embodiments described herein are intended to be merely illustrative of the principles underlying the inventive concept. It is therefore contemplated that various modifications of the disclosed embodiments will, without departing from the inventive spirit and scope, be apparent to persons of ordinary skill in the art. They are not intended to limit the inventive embodiments to any precise form described. In particular, it is contemplated that functional implementation of the various inventive embodiments described herein may be implemented equivalently in hardware, software, firmware, and/or other available functional components or building blocks. No specific limitation is intended to a particular arrangement or programmatic sequence. Other variations and inventive embodiments are possible in light of above teachings, and it is not intended that this Detailed Description limit the inventive scope, but rather by the Claims following herein.

What is claimed:

1. A system comprising:
a server operatively coupled to a communications network comprising;
a processor;
a computer readable storage medium operatively coupled to the processor;
a database operatively stored in the computer readable storage medium, the database comprising;
a first database component operative to maintain a plurality of tutor records, each tutor record being associated with an individual tutor, each tutoring record including tutor data representing an available tutoring subject and a tutor's locality;
a second database component operative to maintain a plurality of student records, each student record being associated with an individual student, each student record including student data representing a requested tutoring subject and a student's locality;
a database engine operatively loaded into the computer readable storage medium including instructions which when executed by the processor cause the processor to;
determine a suggested tutor/student allocation in dependence on a correspondence of the data representing a tutoring subject and a locality among the tutor and student records;
generate a suggested tutor/student allocation; and,
output the suggested tutor/student allocation in a tiered order of preference.

2. The system according to claim 1 wherein the plurality of tutor records further comprises tutor data representing tutor qualifications, tutor availability, prior student feedback ratings, prior student feedback ratings and billing rates.

3. The system according to claim 2 wherein the plurality of student records further comprises student data representing student availability, student preferences and relationships with one or more tutoring providers.

4. The system according to claim 3 wherein the database engine further comprises instructions which when executed by the processor cause the processor to generate the suggested tutor/student allocation in further dependence on a correspondence of the data representing tutor and student availability.

5. The system according to claim 1 wherein a first tier of the tiered order of preference represents a group of most preferred tutors, a second tier represents a group of second most preferred tutors and a third tier representing a group of third most preferred tutors available for the suggested tutor/student allocation.

6. The system according to claim 5 wherein the database engine further includes instructions which when executed by the processor causes the processor to;
send a message to each tutor in the first tier which requests acceptance of the suggested tutor/student allocation;
if no acceptance is received from the first tier tutors within the predefined time period, send a message to each tutor in the second tier which requests acceptance of the suggested tutor/student allocation;
if no acceptance is received from the second tier tutors within the predefined time period, send a message to each tutor in the third tier which requests acceptance of the suggested tutor/student allocation; and,
if no acceptance is received from the third tier tutors within the predefined time period, send a message to an administrator.

7. The system according to claim 1 further comprising a third database component operative to maintain a plurality of accounting records, each accounting record being associated with an established tutor/student relationship and data representing accounts receivable and accounts payable.

8. The system according to claim 7 wherein the database engine further comprises instructions which when executed by the processor causes the processor to output the accounting records in a standardized data exchange format.

9. The system according to claim 7 wherein the data representing accounts payable data includes electronically submitted timecard data received from each tutor associated with the established tutor/student relationship.

10. The system according to claim 7 wherein the standardized data exchange format is selected from the group consisting of; an extensible markup language format, a QuickBooks format, a Peachtree Accounting format, an open financial exchange format, an Office Accounting Express format and a spreadsheet format.

11. A system comprising:
a server operatively coupled to a communications network comprising;
a processor;
a computer readable storage medium operatively coupled to the processor;
a database operatively stored in the computer readable storage medium, the database comprising;
a first database component operative to maintain a plurality of tutor records, each tutor record being associated with an individual tutor, each tutoring record including tutor data representing an available tutoring subject and a tutor's locality;
a second database component operative to maintain a plurality of student records, each student record being associated with an individual student, each student record including student data representing a requested tutoring subject and a student's locality;
a database engine operatively loaded into the computer readable storage medium including instructions which when executed by the processor cause the processor to;
determine a suggested tutor/student allocation in dependence on a correspondence of the data representing a tutoring subject and a locality among the tutor and student records;
generate a suggested tutor/student allocation;
output the suggested tutor/student allocation in a tiered format such that the suggested tutors are allocated in an order of preference;
send messages to each tutor which requests acceptance of the suggested tutor/student allocation in dependence on the order of preference and a predetermined time period; and,
if an acceptance is not received from the tutors within the predetermined time period, send a message to an administrator.

12. A computer implemented method comprising:
maintaining tutor records in a database, the tutor records including data representing a tutoring subject and a tutor locality;
maintaining student records in the database, the student records including data representing a tutoring subject and an student locality;
determining a suggested tutor/student allocation in dependence on a correspondence of the data representing a tutoring subject and a locality among the tutor and student records:
generating a suggested tutor/student allocation;
outputting the suggested tutor/student allocation such that the tutors of the suggested tutor/student allocation are output in tiered orders of preference.

13. The computer implemented method according to claim 12 further comprising;
sending messages to each tutor which requests acceptance of the suggested tutor/student allocation in dependence on the tiered orders of preference and a predetermined time period; and,
sending a message to an administrator if an acceptance is not received from the tutors within the predetermined time period.

14. The computer implemented method according to claim 13 further comprising maintaining accounting records in the database, the accounting records including tutor timecard data, tutor billing rate data and student account data.

15. The computer implemented method according to claim 14 further comprising;
recording a time entry in the tutor timecard data corresponding to a tutoring session conducted by a tutor associated with the current tutor/student relationship;
computing an amount owed to the tutor in dependence on the time entry data and the tutor billing rate data; and,
recording a charge in the student account data in dependence on the computed amount owed to the tutor.

16. The computer implemented method according to claim 14 further comprising outputting the financial records in a standardized data exchange format selected from the group consisting of; an extensible markup language format, a QuickBooks format; a Peachtree Accounting format, an open financial exchange format, an Office Accounting Express format and a spreadsheet format.

17. A computer program product embodied in a tangible form comprising instnictions which when executed by a processor coupled to a network, cause the processor to:
store a database in a computer read able storage medium coupled to the processor;
maintain tutor records in the database, the tutor records including data representing a tutoring subject and a tutor locality;
maintain student records in the database, the student records including data representing a tutoring subject and an student locality;
determine a suggested tutor/student allocation in dependence on a correspondence of the data representing a tutoring subject and a locality among the tutor and student records;
generate a suggested tutor/student allocation; and,
output the suggested tutor/student allocation such that the tutors of the suggested tutor/student allocation are output in tiered orders of preference.

18. The computer program product according to claim 17 further comprising the executable instructions to:
send messages over the network to each tutor which requests acceptance of the suggested tutor/student allocation in dependence on the orders of preference and a predetermined time period; and,
if an acceptance is not received from the tutors within the predetermined time period, send a message to an administrator.

19. The computer program product according to claim 17 further comprising executable instructions to maintain a plurality of accounting records, each accounting record being associated with an established tutor/student relationship and data representing accounts receivable and accounts payable.

20. The computer program Product according to claim 19 further -comprising executable instnictions to output the accounting records in a standardized data exchange format is selected from the group consisting of; an extensible markup language format, a QuickBooks format, a Peachtree Accounting format, an open financial exchange format, an Office Accounting Express format and a spreadsheet format.

21. (canceled)

22. (canceled)

23. (canceled)

24. (canceled)

25. (canceled)
